(19) United States
(12) Patent Application Publication
(10) Pub. No.: US 2024/0387886 A1
(43) Pub. Date: Nov. 21, 2024

(54) ANODE COATING FOR ALL-SOLID-STATE LI-ION BATTERY

(71) Applicant: Arkema France, Colombes (FR)

(72) Inventor: Gregory SCHMIDT, Pierre-Benite (FR)

(21) Appl. No.: 18/692,885

(22) PCT Filed: Sep. 23, 2022
(86) PCT No.: PCT/FR2022/051795

§ 371 Date: Mar. 18, 2024

(30) Foreign Application Priority Data
Sep. 27, 2021 (FR) FR21.10145

(51) Int. Cl. H01M 10/42; H01M 4/02; H01M 4/139; H01M 4/36; H01M 4/62; H01M 10/0525

(52) U.S. Cl. CPC H01M 10/4235; H01M 4/139; H01M 4/366; H01M 4/623; H01M 4/628; H01M 10/0525; H01M 2004/027

(57) ABSTRACT

The present invention relates generally to the field of the storage of electrical energy in rechargeable storage batteries of Li-ion type. More specifically, the invention relates to an anode coating for a completely solid Li-ion battery. The invention also relates to a process for the preparation of said coating. The invention also relates to an anode coated with this coating, to the process for the manufacture of such an anode and also to the Li-ion storage batteries comprising such an anode.

### FIELD OF THE INVENTION

The present invention relates generally to the field of the storage of electrical energy in rechargeable storage batteries of Li-ion type. More specifically, the invention relates to an anode coating for an all-solid Li-ion battery. The invention also relates to a process for the preparation of said coating. The invention also relates to an anode covered with this coating, to the process for the manufacture of such an anode and also to the Li-ion storage batteries comprising such an anode.

### TECHNICAL BACKGROUND

A lithium storage battery can be used as power supply for a variety of electronic devices ranging from mobile phones, laptops and small domestic electronic devices to vehicles and to high-capacity energy storage devices and others, and the demand for lithium storage batteries is ceaselessly growing.

The existing lithium storage batteries generally use liquid electrolytes containing an organic substance. These liquid electrolytes advantageously have a high ion conductivity but require additional safety devices due to the risk of escape of liquid, of fire or of explosion at high temperature.

To attempt to solve the safety problems associated with liquid electrolytes, recently entirely solid batteries using solid electrolytes have been developed.

An all-solid battery generally comprises a positive electrode, a solid electrolyte and a negative electrode. The positive electrode comprises a positive electrode active material and a solid electrolyte, and additionally comprises an electron-conducting material and a binder. The solid electrolyte comprises one or more elements from the following list: polymer, plasticizer, lithium salt, inorganic particle, ionic liquid. Like the positive electrode, the negative electrode comprises a negative electrode active material and a solid electrolyte, and additionally comprises a conductive material and a binder.

However, there is for the moment no solid electrolyte which meets the specifications for bulk use of the all-solid battery. This is because, for the solid electrolyte, it is generally difficult to combine ion conductivity, electrochemical stability, mechanical strength and compatibility with the anode or cathode materials.

Mention may in particular be made, as example, of the inorganic compounds which exhibit very high ion conductivities but which show an electrochemical instability with regard to the potentials at the anode and high potentials at the cathode. (Y. Zhu, ACS Appl. Mater. Interfaces, 2015, 7, 23685-23693)

There still exists a need to develop a solution which makes it possible to render an anode compatible with a solid electrolyte in an all-solid Li-ion battery. Above all, there exists a need to solve the problem of variations in volume of the anode during charging and discharging cycles. Lastly, in the particular case of an anode of lithium metal, there exists a need to provide an anode which is protected against the formation of dendrites by an effective means.

It is thus an aim of the invention to provide a coating which can be directly applied to a Li-ion battery negative electrode, then making it possible to have a physical separation between the solid electrolyte and the electrode active substance. Thus, the present invention provides a negative electrode comprising a first layer consisting of a customary negative electrode and a second layer consisting of an anode coating according to the present invention.

The invention is also targeted at providing a process for the manufacture of said anode coating. Finally, the invention relates to an anode exhibiting such a coating and to the process for the manufacture of such an anode.

Finally, the invention is targeted at providing rechargeable Li-ion storage batteries comprising such an anode.

### SUMMARY OF THE INVENTION

The technical solution proposed by the present invention is to provide an anode coating which renders the cathode compatible with a solid electrolyte in an all-solid battery.

The invention relates first to an anode coating consisting of:
a. one or more poly(vinylidene fluoride)s,
b. a lithium salt, and
c. a conductivity additive.

The invention also relates to a process for the manufacture of an anode coating from an ink obtained by mixing all the constituents of the coating.

The invention also relates to an anode for a lithium-ion battery, said anode consisting of a layer of negative electrode active material covered with a coating layer according to the invention.

The invention also relates to a process for the manufacture of a Li-ion battery negative electrode, said process comprising the following operations:
providing an anode,
depositing, on said anode, a coating layer.

Another subject-matter of the invention is a Li-ion storage battery comprising a negative electrode, a positive electrode and an all-solid electrolyte, in which the anode is as described above.

The present invention makes it possible to overcome the disadvantages of the state of the art. It provides an ion-conducting coating having a homogeneous distribution of its dielectric constant while at the same time maintaining sufficient mechanical strength to avoid the formation of dendrites. This coating demonstrates good reduction stability and good flexibility, thereby allowing it to withstand variations in anode volume during charging and discharging cycles.

In the particular case of a lithium anode, the coating according to the invention makes it possible to arrest the growth of dendrites which can cause short circuits, the good homogeneity of the dielectric constant making it possible to avoid the formation of regions with a high concentration of lithium ions. This coating also makes it possible to form a solid electrolyte interface (SEI) which is stable and has low resistivity on the lithium metal, thereby improving the performance and lifetime of all-solid batteries.

### DESCRIPTION OF EMBODIMENTS OF THE INVENTION

The invention is now described in more detail and in a non-limiting way in the description which follows.

According to a first aspect, the invention relates to an anode coating consisting of:
a. one or more poly(vinylidene fluoride)s (component A),
b. at least one lithium salt (component B), and
c. at least one conductivity additive (component C).

According to various implementations, said coating comprises the following characteristics, if appropriate combined. The contents indicated are expressed by weight, unless otherwise indicated.

### Component A

The semi-crystalline fluoropolymer used in the invention is a polymer based on vinylidene difluoride and is denoted generically by the abbreviation PVDF.

According to one embodiment, the PVDF is a poly(vinylidene fluoride) homopolymer or a mixture of vinylidene fluoride homopolymers.

According to one embodiment, the PVDF is a poly(vinylidene fluoride) homopolymer or a copolymer of vinylidene difluoride with at least one comonomer compatible with vinylidene difluoride.

According to one embodiment, the PVDF is semi-crystalline.

The comonomers compatible with vinylidene difluoride can be halogenated (fluorinated, chlorinated or brominated) or non-halogenated.

Examples of appropriate fluorinated comonomers are: vinyl fluoride, tetrafluoroethylene, hexafluoropropylene, trifluoropropenes and in particular 3,3,3-trifluoropropene, tetrafluoropropenes and in particular 2,3,3,3-tetrafluoropropene or 1,3,3,3-tetrafluoropropene, hexafluoroisobutylene, perfluorobutylethylene, pentafluoropropenes and in particular 1,1,3,3,3-pentafluoropropene or 1,2,3,3,3-pentafluoropropene, perfluorinated alkyl vinyl ethers and in particular those of general formula Rf—O—CF—CF₂, Rf being an alkyl group, preferably a C₁ to C₄ alkyl group (preferred examples being perfluoro(propyl vinyl ether) and perfluoro(methyl vinyl ether)).

The fluorinated comonomer can comprise a chlorine or bromine atom. It can in particular be chosen from bromotrifluoroethylene, chlorofluoroethylene, chlorotrifluoroethylene and chlorotrifluoropropene. Chlorofluoroethylene can denote either 1-chloro-1-fluoroethylene or 1-chloro-2-fluoroethylene. The 1-chloro-1-fluoroethylene isomer is preferred. Chlorotrifluoropropene is preferably 1-chloro-3,3,3-trifluoropropene or 2-chloro-3,3,3-trifluoropropene.

The VDF copolymer can also comprise non-halogenated monomers, such as ethylene, and/or acrylic or methacrylic comonomers.

The fluoropolymer preferably contains at least 50 mol % of vinylidene difluoride.

According to one embodiment, the PVDF is a copolymer of vinylidene fluoride (VDF) and of hexafluoropropylene (HFP) (P(VDF-HFP)), having a percentage by weight of hexafluoropropylene monomer units of from 2% to 23%, preferably from 4% to 15% by weight, with respect to the weight of the copolymer.

According to one embodiment, the PVDF is a mixture of a poly(vinylidene fluoride) homopolymer and of a VDF-HFP copolymer.

According to one embodiment, the PVDF is a copolymer of vinylidene fluoride and of tetrafluoroethylene (TFE).

According to one embodiment, the PVDF is a copolymer of vinylidene fluoride and of chlorotrifluoroethylene (CTFE).

According to one embodiment, the PVDF is a VDF-TFE-HFP terpolymer. According to one embodiment, the PVDF is a VDF-TrFE-TFE terpolymer (TrFE being trifluoroethylene). In these terpolymers, the content by weight of VDF is at least 10%, the comonomers being present in variable proportions.

According to one embodiment, the PVDF is a mixture of two or more VDF-HFP copolymers. The presence of comonomer of HFP type makes it possible to improve the chemical stability of the coating with respect to lithium metal.

According to one embodiment, the PVDF comprises monomer units carrying at least one of the following functions: carboxylic acid, carboxylic acid anhydride, carboxylic acid ester, epoxy (such as glycidyl), amide, hydroxyl, carbonyl, mercapto, sulfide, oxazoline, phenolic, ester, ether, siloxane, sulfonic, sulfuric, phosphoric or phosphonic. The function is introduced by a chemical reaction which can be grafting or a copolymerization of the fluorinated monomer with a monomer carrying at least one of said functional groups and a vinyl function capable of copolymerizing with the fluorinated monomer, according to techniques well known to a person skilled in the art.

According to one embodiment, the functional group carries a carboxylic acid function which is a group of (meth)acrylic acid type chosen from acrylic acid, methacrylic acid, hydroxyethyl (meth)acrylate, hydroxypropyl (meth)acrylate and hydroxyethylhexyl (meth)acrylate.

According to one embodiment, the units carrying the carboxylic acid function additionally comprise a heteroatom chosen from oxygen, sulfur, nitrogen and phosphorus.

According to one embodiment, the functionality is introduced by means of the transfer agent used during the synthesis process. The transfer agent is a polymer with a molar mass of less than or equal to 20 000 g/mol carrying functional groups chosen from the following groups: carboxylic acid, carboxylic acid anhydride, carboxylic acid ester, epoxy (such as glycidyl), amide, hydroxyl, carbonyl, mercapto, sulfide, oxazoline, phenolic, ester, ether, siloxane, sulfonic, sulfuric, phosphoric or phosphonic. An example of transfer agent of this type is acrylic acid oligomers.

The content of functional groups in the PVDF is at least 0.01 mol %, preferably at least 0.1 mol %, and at most 15 mol %, preferably at most 10 mol %.

The PVDF preferably has a high molecular weight. The term “high molecular weight”, as used here, is understood to mean a PVDF having a melt viscosity of greater than 100 Pa·s, preferably of greater than 500 Pa·s, more preferably of greater than 1000 Pa·s, advantageously of greater than 2000 Pa·s. The viscosity is measured at 232° C., at a shear gradient of 100 s⁻¹, using a capillary rheometer or a parallel-plate rheometer, according to Standard ASTM D3825. The two methods give similar results.

The PVDF homopolymers and the VDF copolymers used in the invention can be obtained by known polymerization methods, such as emulsion polymerization.

According to one embodiment, they are prepared by an emulsion polymerization process in the absence of a fluorinated surfactant.

The polymerization of the PVDF results in a latex generally having a solids content of from 10% to 60% by weight, preferably from 10% to 50%, and having a weight-average particle size of less than 1 micrometre, preferably of less than 1000 nm, preferably of less than 800 nm and more preferably of less than 600 nm. The weight-average size of the particles is generally at least 10 nm. preferably at least 50 nm, and advantageously the average size is within the range from 100 to 400 nm. The polymer particles can form agglomerates, referred to as secondary particles, the weight-average size of which is less than 5000 μm, preferably less than 1000 μm, advantageously of between 1 and 80 micrometres and preferably from 2 to 50 micrometres. The agglomerates can break up into discrete particles during the formulation and the application to a substrate.

According to some embodiments, the PVDF homopolymer and the VDF copolymers are composed of biobased VDF. The term “biobased” means “resulting from biomass”. This makes it possible to improve the ecological footprint of the coating. Biobased VDF can be characterized by a content of renewable carbon, that is to say of carbon of natural origin originating from a biomaterial or from biomass, of at least 1 atom %, as determined by the content of ¹⁴C according to Standard NF 35 EN 16640. The term “renewable carbon” indicates that the carbon is of natural origin and originates from a biomaterial (or from biomass), as indicated below. According to some embodiments, the biocarbon content of the VDF can be greater than 5%, preferably greater than 10%, preferably greater than 25%, preferably greater than or equal to 33%, preferably greater than 50%, preferably greater than or equal to 66%, preferably greater than 75%, preferably greater than 90%, preferably greater than 95%, preferably greater than 98%, preferably greater than 99%, advantageously equal to 100%.

### Component B

By way of nonlimiting examples, the lithium salt (or the lithium salts) are chosen from LiPF₆ (lithium hexafluorophosphate), LiFSI (lithium bis(fluorosulfonyl)imide), TFSI (lithium bis(trifluoromethylsulfonyl)imide), LiTDI (lithium 2-trifluoromethyl-4,5-dicyanoimidazolate), LiPOF₂, LiB(C₂O₄)₂, LiF₂B(C₂O₄)₂, LiBF₄, LiNO₃, LiClO₄ and the mixtures of two or more of the salts mentioned.

### Component C

The conductivity additive can be an organic molecule or a mixture of organic molecules capable of swelling the fluoropolymer without dissolving it and having a dielectric constant of greater than 1. According to one embodiment, the component C is chosen from ethers, which are linear or cyclic, esters, lactones, nitriles, carbonates and ionic liquids.

By way of non-limiting examples, mention may be made, among the ethers, of linear or cyclic ethers, such as, for example, dimethoxyethane (DME), methyl ethers of oligoethylene glycols of 2 to 5 oxyethylene units, dioxolane, dioxane, dibutyl ether, tetrahydrofuran and their mixtures.

Mention may be made, among the esters, of phosphoric acid esters or sulfite esters. Mention may be made, for example, of methyl formate, methyl acetate, methyl propionate, ethyl acetate, butyl acetate, γ-butyrolactone or their mixtures.

Mention may in particular be made, among the lactones, of cyclohexanone.

Mention may be made, among the nitriles, for example, of acetonitrile, pyruvonitrile, propionitrile, methoxypropionitrile, dimethylaminopropionitrile, butyronitrile, isobutyronitrile, valeronitrile, pivalonitrile, isovaleronitrile, glutaronitrile, methoxyglutaronitrile, 2-methylglutaronitrile, 3-methylglutaronitrile, adiponitrile, malononitrile and their mixtures.

Mention may be made, among the carbonates, for example, of cyclic carbonates, such as, for example, ethylene carbonate (EC) (CAS: 96-49-1), propylene carbonate (PC) (CAS: 108-32-7), butylene carbonate (BC) (CAS: 4437-85-8), dimethyl carbonate (DMC) (CAS: 616-38-6), diethyl carbonate (DEC) (CAS: 105-58-8), ethyl methyl carbonate (EMC) (CAS: 623-53-0), diphenyl carbonate (CAS: 102-09-0), methyl phenyl carbonate (CAS: 13509-27-8), dipropyl carbonate (DPC) (CAS: 623-96-1), methyl propyl carbonate (MPC) (CAS: 1333-41-1), ethyl propyl carbonate (EPC), vinylene carbonate (VC) (CAS: 872-36-6), fluoroethylene carbonate (FEC) (CAS: 114435-02-8), trifluoropropylene carbonate (CAS: 167951-80-6) or their mixtures.

Mention may in particular be made, among the ionic liquids, of EMIM:FSI, PYR:FSI, EMIM:TFSI, PYR:TFSI, EMIM:BOB, PYR:BOB, EMIM:TDI, PYR:TDI, EMIM:BF4 or PYR:BF4.

The composition by weight of the anode coating according to the invention is:
Component A with a ratio by weight of between 20% and 80%,
Component B with a ratio by weight of between 1% and 40%,
Component C with a ratio by weight of between 2% and 50%, the sum of these ratios being 100%.

The invention also relates to a process for the manufacture of the anode coating described above, by the solvent route, from an ink obtained by mixing all the constituents of the coating in a solvent.

The inks making it possible to prepare the coatings can be produced by any type of mixer known to a person skilled in the art, such as a planetary mixer, centrifuge, orbital mixer, stirrer shaft or Ultra-Turrax. The different constituents of the ink are not added in a precise order. The ink can be manufactured at different temperatures ranging from ambient temperature up to the boiling point of the solvent used to manufacture the ink.

The solvent used is preferably a polar solvent with a Hansen parameter of greater than 2. By way of non-limiting example, mention may in particular be made of acetone, triethyl acetylcitrate (TEAC), γ-butyrolactone (GBL), cyclohexanone (CHO), cyclopentanone (CPO), dibutyl phthalate (DBP), dibutyl sebacate (DBS), diethyl carbonate (DEC), diethyl phthalate (DEP), dihydrolevoglucosenone (Cyrene), dimethylacetamide (DMAc), N,N-dimethylformamide (DMF), dimethyl sulfoxide (DMSO), 1,4-dioxane, 3-heptanone, hexamethylphosphoramide (HMPA), 3-hexanone, methyl ethyl ketone (MEK), N-methyl-2-pyrrolidinone (NMP), 3-octanone, 3-pentanone, propylene carbonate (PC), tetrahydrofuran (THF), tetramethylurea (TMU), triacetin, triethyl citrate (TEC), triethyl phosphate (TEP), trimethyl phosphate (TMP), N,N,N′,N′-tetrabutylsuccindiamide (TBSA) or a mixture of two or more of the solvents mentioned.

According to one embodiment, the porosity of the coated anode according to the invention is less than 10%, preferably less than 5%.

The porosity of the coated electrode (CE) is obtained according to the following calculation described in the publication by M. Cai, Nature Communications, 10, 2019, 4597:

$$p = \frac{{V}_{CE} - {V}_{denseCE}}{{V}_{CE}}$$

where V_{CE} represents the true volume of the coated electrode and is calculated by multiplying the surface area of the coated electrode by the thickness of the coated electrode. V_{denseCE} represents the volume occupied by each of the constituents without any porosity and is calculated according the following formula:

$${V}_{denseCE} = \sum \frac{{m}_{i}}{{d}_{i}}$$

V_{denseCE} is the sum of the volume occupied by each constituent of the coated electrode.

The thickness of this coating can range from 0.1 to 100 μm, preferentially from 0.1 to 50 μm and more preferentially from 0.1 to 35 μm.

The invention also relates to an anode for an all-solid lithium-ion battery, said anode comprising, preferably consisting of, an active substance covered with a coating layer according to the invention. Preferably, said active substance of the anode is deposited on a metal support.

According to one embodiment, the active substance in the negative electrode is chosen from graphite, lithium titanate of Li₄Ti₅O₁₂ type, titanium oxide TiO₂, silicon or a lithium/silicon alloy, a tin oxide, a lithium intermetallic compound, lithium metal or their mixtures.

Apart from the lithium metal, the active substance is mixed with an electron-conducting substance and a binder.

The electron-conducting substance is chosen from carbon blacks, graphites, which are natural or synthetic, carbon fibres, carbon nanotubes, metal fibres and powders, and conductive metal oxides. Preferentially, they are chosen from carbon blacks, graphites, which are natural or synthetic, carbon fibres and carbon nanotubes.

The binder used to manufacture the anode is a polymer chosen from polyolefins (for example: polyethylene or polypropylene), fluoropolymers (PVDF) which can exhibit acid functions, polyacrylic acids (PAA), polyacrylonitriles (PAN), polymers of cellulose type, polyphenylsulfone, polyethersulfone, a phenolic resin, a vinyl ester resin, an epoxy resin, PTFE or a liquid crystal polymer.

Thus, said anode comprises, preferably consists of, an active substance covered with a coating layer according to the present invention comprising, preferably consisting of: a) at least one poly(vinylidene fluoride) (component A), b) at least one lithium salt (component B) and at least one conductivity additive (component C). Preferably, said anode has a porosity as defined in the present application.

The invention also relates to a process for the manufacture of a Li-ion battery negative electrode, said process comprising the following operations:
providing an anode,
depositing, on said anode, a coating layer according to the invention.

Thus, the present invention provides a negative electrode comprising, preferably consisting of, a metal support on which is deposited an active substance covered with a coating layer according to the present invention comprising, preferably consisting of: a) at least one poly(vinylidene fluoride) (component A), b) at least one lithium salt (component B) and at least one conductivity additive (component C).

This coating can be produced by any deposition method known to a person skilled in the art, such as coating by the solvent route, dipping-withdrawal method, centrifugal coating method, spray coating method or method of coating by calendering. These deposition techniques can be carried out at different temperatures which can range from 5° C. up to 180° C.

The metal support of the anode is generally made of copper. The metal supports can be surface-treated and have a conductive primer with a thickness of 5 μm or more. The supports can also be woven or non-woven fabrics made of carbon fibre.

Another subject-matter of the invention is an all-solid Li-ion storage battery comprising a negative electrode, a positive electrode and an all-solid electrolyte, in which the anode is as described above.

According to one embodiment, the cathode of said battery is also covered with a coating layer according to the invention.

### EXAMPLES

The following examples illustrate the scope of the invention in a non-limiting way.

### Fluoropolymer (FP) Solution Preparation

14.992 g of VDF-HFP copolymer with a content by weight of HFP of 23% are dissolved in 85.753 g of acetone using a planetary mixer at 2000 rpm for six times 1 min in order to have complete dissolution.

### Preparation of the Ink I for Coating: FP/LiFSI/S1 60/20/20

0.441 g of LiFSI is dissolved in 0.449 g of tetraethylene glycol dimethyl ether (CAS 143-24-8) using a magnetic stirrer at 21° C. for 10 min. Then, 8.826 g of a 15% solution of FP in acetone are added.

### Preparation of the Ink II for Coating: FP/LiFSI/MPCN 60/20/20

0.3986 g of LiFSI is dissolved in 0.3986 g of methoxypropionitrile (CAS 110-67-8) using a magnetic stirrer at 21° C. for 10 min. Then, 7.972 g of a 15% solution of FP in acetone are added.

### Preparation of the Ink III for Coating: FP/LiFSI/S1 40/30/30

0.528 g of LiFSI is dissolved in 0.528 g of tetraethylene glycol dimethyl ether (CAS 143-24-8) using a magnetic stirrer at 21° C. for 10 min. Then, 4.675 g of a 15% solution of FP in acetone are added.

### Coating of the Lithium Metal With the Ink III

A foil of lithium metal having a thickness of 200 μm is coated with the ink III with the aid of a coating blade. The thickness of the wet film deposited is 50 μm. After drying at ambient temperature for 2 hours, the thickness of the deposited film is measured at 38 μm. The electrode is then calendered to obtain a deposit of 2 μm on the lithium metal. The ionic conductivity is measured by impedance spectroscopy. The value obtained is 0.553 mS/cm.

### Dendrite Tests

A dendrite test is carried out to compare the coating on the Li metal obtained with the ink III versus a standard liquid electrolyte.

### Method

The method consists of charging and discharging a symmetrical Li metal/Li metal battery; the potential of the battery is then measured. This potential is proportional to the surface area of the electrodes, therefore the appearance of dendrites results in an increase in potential.

### System Used

Cathode: Coated or non-coated lithium metal
Anode: Lithium metal

The battery is charged using a positive current of 0.25 mA to an energy density of 0.25 mAh. The battery is then discharged using a negative current of 0.25 mA to an energy density of 0.25 mAh.

In the case of liquid electrolyte, a porous PE separator is soaked in an electrolyte solution containing 1 M LiFSI in EC/EMC 3/7 by volume.

The time required for doubling of the initial potential of the battery is shown in Table 1.

TABLE 1

| Technology | Time | |
|---|---|---|
| Ink III coating | >384 | H |
| Liquid electrolyte | 24 | H |

1. An anode coating consisting of:
a. at least one poly(vinylidene fluoride) (PVDF) (component A),
b. at least one lithium salt (component B), and
c. at least one conductivity additive (component C).

2. The anode coating of claim 1, in which said component A is chosen from poly(vinylidene fluoride) homopolymers and copolymers of vinylidene difluoride with at least one comonomer is selected from the group consisting of vinyl fluoride, tetrafluoroethylene, hexafluoropropylene, 3,3,3-trifluoropropene, 2,3,3,3-tetrafluoropropene, 1,3,3,3-tetrafluoropropene, hexafluoroisobutylene, perfluorobutylethylene, 1,1,3,3,3-pentafluoropropene, 1,2,3,3,3-pentafluoropropene, perfluoro(propyl vinyl ether), perfluoro(methyl vinyl ether), bromotrifluoroethylene, chlorofluoroethylene, chlorotrifluoroethylene, chlorotrifluoropropene, ethylene and their mixtures.

3. The anode coating of claim 1, in which the PVDF comprises monomer units carrying at least one of the following functions: carboxylic acid, carboxylic acid anhydride, carboxylic acid ester, epoxy, -amide, hydroxyl, carbonyl, mercapto, sulfide, oxazoline, phenolic, ester, ether, siloxane, sulfonic, sulfuric, phosphoric or phosphonic.

4. The anode coating of claim 1, in which said component B is selected from the group consisting of LiPF₆ (lithium hexafluorophosphate), LiFSI (lithium bis (fluorosulfonyl) imide), TFSI (lithium bis(trifluoromethylsulfonyl)imide), LiTDI (lithium 2-trifluoromethyl-4,5-dicyanoimidazolate), LiPOF₂, LiB(C₂O₄)₂, LiF₂B(C₂O₄)₂, LiBF₄, LiNO₃, LiClO₄ and mixtures thereof.

5. The anode coating of claim 1, in which the component C is selected from the group consisting of liner ethers, cyclic ethers, esters, lactones, nitriles, carbonates and ionic liquids.

6. The anode coating of claim 1, having a thickness ranging from 0.1 to 100 μm.

7. The anode coating of claim 1, having the following composition by weight:
Component A with a ratio of between 20% and 80%,
Component B with a ratio of between 1% and 40%,
Component C with a ratio of between 2% and 50%, the sum of these ratios being 100%.

8. A process for the manufacture of the anode coating of claim 1 comprising the steps of:
a) combining component A, component B and Component C in a solvent to provide an ink,
b) applying said ink on to an anode,
c) drying the ink on the anode.

9. The process of claim 8, in which said solvent is selected from the group consisting of: acetone, triethyl acetylcitrate, γ-butyrolactone, cyclohexanone, cyclopentanone, dibutyl phthalate, dibutyl sebacate, diethyl carbonate, diethyl phthalate, dihydrolevoglucosenone, dimethylacetamide, N,N-dimethylformamide, dimethyl sulfoxide, 1,4-dioxane, 3-heptanone, hexamethylphosphoramide, 3-hexanone, methyl ethyl ketone, N-methyl-2-pyrrolidinone, 3-octanone, 3-pentanone, propylene carbonate, tetrahydrofuran, tetramethylurea, triacetin, triethyl citrate, triethyl phosphate, trimethyl phosphate, N,N′-tetrabutylsuccinamide and their mixtures.

10. An anode for an all-solid lithium-ion battery, said anode consisting of an active substance covered with the coating of claim 1.

11. The anode of claim 9, in which said active substance is selected from the group consisting of graphite, lithium titanate of Li₄Ti₅O₁₂ type, titanium oxide TiO₂, silicon, a lithium/silicon alloy, a tin oxide, a lithium intermetallic compound, or their mixtures.

12. The anode of claim 10, said anode having a porosity of less than 10%.

13. A process for the manufacture of a Li-ion battery negative electrode, said process comprising:
providing an anode,
depositing, on said anode, the coating layer of claim 1.

14. An all solid Li-ion storage battery comprising a cathode, the anode of claim 10 and an all-solid electrolyte.

15. An all solid Li-ion storage battery, in which the cathode is covered with the coating layer of claim 1.
